(19) United States
(12) Patent Application Publication
(10) Pub. No.: US 2018/0014021 A1
(43) Pub. Date: Jan. 11, 2018

(54) PREDICTION IN IMAGE AND VIDEO COMPRESSION

(71) Applicant: Cisco Technology, Inc., San Jose, CA (US)

(72) Inventors: Steinar Midtskogen, Oslo (NO); Knut Inge Hvidsten, Oslo (NO)

(21) Appl. No.: 15/361,776

(22) Filed: Nov. 28, 2016

Related U.S. Application Data
(60) Provisional application No. 62/358,254, filed on Jul. 5, 2016.

(51) Int. Cl. H04N 19/159; H04N 19/13; H04N 19/61; H04N 19/117; H04N 19/124; H04N 19/51; H04N 19/176; H04N 19/172; H04N 19/182; H04N 19/184

(52) U.S. Cl. CPC H04N 19/159; H04N 19/124; H04N 19/13; H04N 19/61; H04N 19/51; H04N 19/117; H04N 19/172; H04N 19/182; H04N 19/184; H04N 19/176

(57) ABSTRACT

Presented herein are techniques for exploiting correlations between channels of an image or video frame to be encoded. The correlations between channels in an initial prediction are used to calculate the mapping. The method also determines whether the new prediction is an improvement over the original prediction if no extra signaling is to be used. The method may significantly improve the compression efficiency for images or video containing high correlations between the channels.

### CROSS REFERENCE TO RELATED APPLICATION

The present application claims priority to U.S. Provisional Application No. 62/358,254 filed Jul. 5, 2016, the entirety of which is incorporated herein by reference.

### TECHNICAL FIELD

The present disclosure relates to image and video compression.

### BACKGROUND

Digital color image and video compression techniques split video images into separate channels (such as luminance (Y) and chrominance (U and V) or red green blue (RGB), with or without an alpha channel), form predictions for blocks of the image, and the residual for each block is then coded. The efficiency of the compression greatly depends on the predictions.

The predictions are made from a block's spatial or temporal neighborhood that has already been coded, so that an identical prediction can be constructed by the decoder. Apart from some shared information such as motion vectors, each channel forms its own separate prediction. There are often some structural similarities between the channels which will be passed on to the residuals, and if these similarities can be identified, the encoder can avoid transmitting similar information for each channel and thus improve the compression.

### BRIEF DESCRIPTION OF THE DRAWINGS

FIG. 1 is a flow chart generally depicting the prediction techniques presented herein, according to an example embodiment.

FIG. 2 is a flow diagram depicting encoder operations of the prediction method, according to an example embodiment.

FIG. 3 is a flow diagram depicting decoder operations of the prediction method, according to an example embodiment.

FIG. 4 is a diagram illustrating a plot of luminance samples and chrominance samples for an image block, and indicating how a chrominance component can be predicted from a reconstructed luminance component, according to an example embodiment.

FIG. 5 is a block diagram of an encoder configured to perform the prediction techniques presented herein, according to an example embodiment.

FIG. 6 is a block diagram of a decoder configured to perform the prediction techniques presented herein, according to an example embodiment.

FIG. 7 is a block diagram of a computing device that may configured to support the prediction techniques presented herein, according to an example embodiment.

### DESCRIPTION OF EXAMPLE EMBODIMENTS

### Overview

Presented herein are techniques for exploiting correlations between channels (also called “components”) of an image or video frame to be encoded. The correlations between channels in an initial prediction are used to calculate a mapping. The method also determines whether the new prediction is likely an improvement over the original prediction. This may significantly improve the compression efficiency for images or video containing high correlations between the components.

In one embodiment, a first component is predicted for a block of pixels in a video frame to produce a predicted first component. A second component is initially predicted for a block of pixels in a video frame to produce an initially predicted second component. One or more parameters are computed for a mapping function between the first component and the second component for the block based on a correlation between the predicted first component and the initially predicted second component for the block. A quality parameter or measure of the first component is computed. A correlation coefficient is computed for the mapping function between the first component and the second component. Depending on the quality parameter or measure and the correlation coefficient, either the initially predicted second component is used for the block or a new predicted second component is computed for the block based on the mapping function and a reconstructed first component for the block.

### DETAILED DESCRIPTION

Techniques are presented herein to improve predictions for components of an image or video frame once a first component of a block of a frame has been coded and reconstructed. One example for one luminance (Y) component and two chrominance (U and V) components for a video frame. A prediction for each component is made by a traditional method. A first component, such as Y, is encoded and reconstructed first, and is then used to improve the predictions for the second and third components, U and V, respectively.

There is frequently a correlation between the values of the different channels/components of a video image, making it possible to reproduce a channel/component from another channel/component and a mapping function. Since it would be costly to transmit the parameters of such a mapping function, a method is presented herein by which the encoder and decoder can perform the same mapping without the need of transmitting extra data.

The method uses the correlations between the components of the initial prediction as an approximation for the correlation between the components of the actual image to be encoded. Then, this mapping may be used to form an improved prediction from a different component that has already been coded and reconstructed. However, if the correlation is weak, or if the original prediction is good, the original prediction is kept and used.

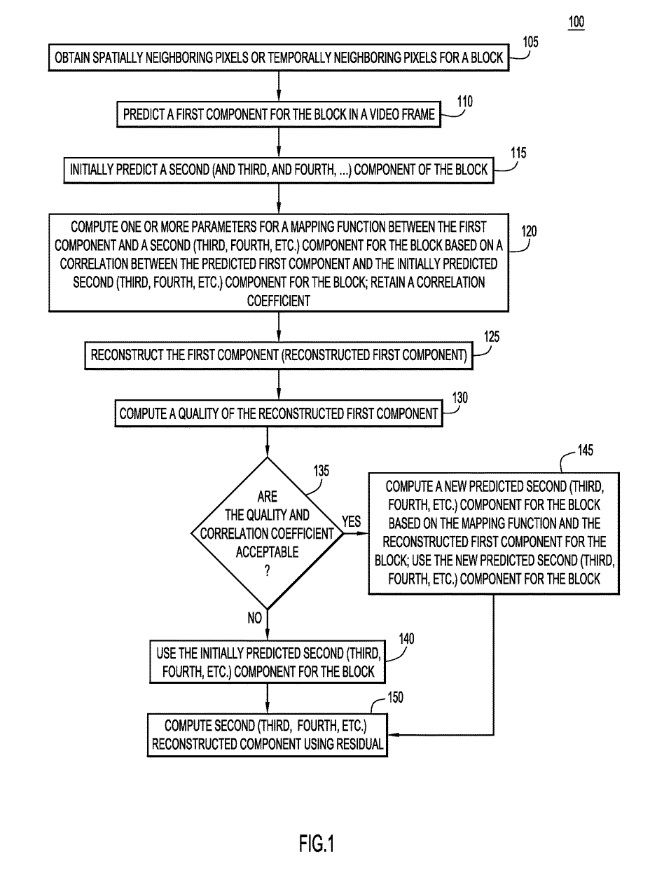

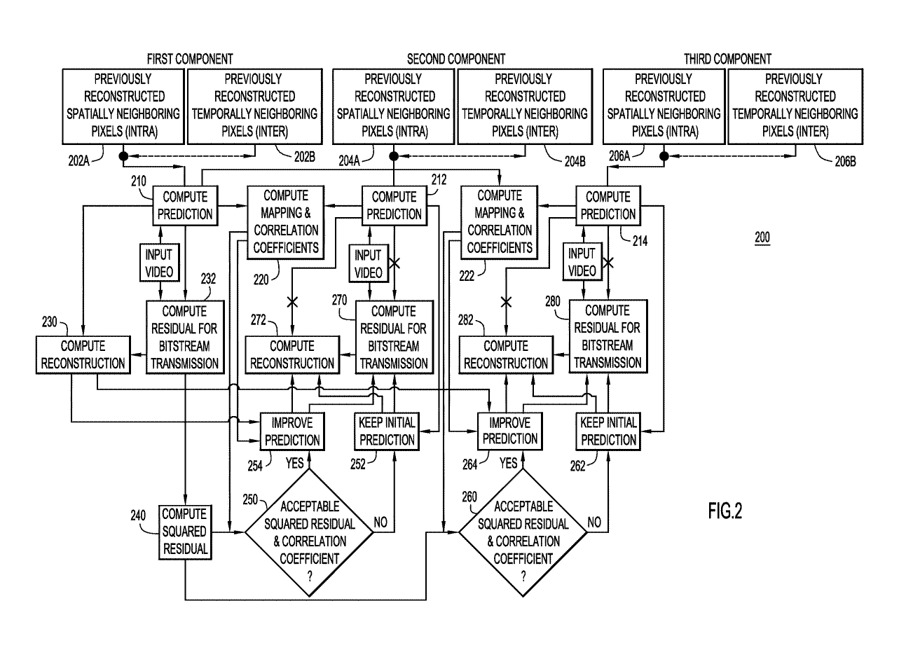

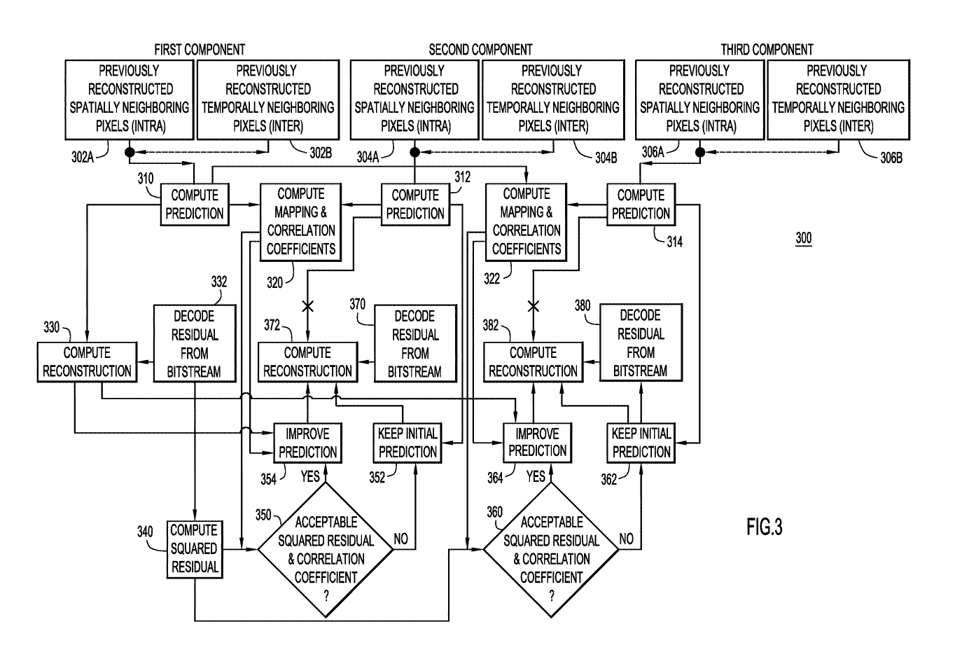

Reference is made to FIG. 1 that shows a flow chart of a prediction method 100 according to an example embodiment. The flow chart of FIG. 1 is intended to be representative of operations performed at the encoder and decoder. A flow diagram specific to operations performed at an encoder is described below in connection with FIG. 2, and a flow diagram specific to operations performed at a decoder is described below in connection with FIG. 3.

The method 100 is applicable to intra-prediction and inter-prediction. Thus, at 105, spatially neighboring pixels (for intra-prediction) or temporally neighboring pixels (for inter-prediction) of a block of a video frame are obtained. At 110, a first component for the block of pixels in the video frame is predicted, and it is referred to as a predicted first component. Again, the operation at 110 may be based on either spatially neighboring pixels of the block (in the case of intra-prediction) or temporally neighboring pixels of the block (in the case of inter-prediction). As an example, the first component may be a luminance (Y) component.

At 115, a second (third, fourth, etc.) component of the block is initially predicted. The output of this step is an initially predicted second (third, fourth, etc.) component of the block. This operation may be based on either spatially neighboring pixels of the block (in the case of intra-prediction) or temporally neighboring pixels of the block (in the case of inter-prediction). As an example, the second component may be a chrominance U component.

At 120, one or more parameters are computed for a mapping function between the first component and the second component for the block based on a correlation between the predicted first component and the initially predicted second component for the block. In deriving the mapping function, a correlation coefficient is derived and it is retained and used in subsequent operations as described below. The correlation between the components are often linear, so f(x)=a*x+b is a simple yet effective mapping function. Using the initial prediction, the parameters a and b are calculated, as well as a sample correlation coefficient r. A new prediction Pu can be formed, expressed by a and b and the reconstructed first component samples Fcr, such that Pu=Fcr*a+b, if the sample correlation coefficient r is sufficiently high and if the quality of the predicted first component is sufficiently high, as will be described below.

At 125, the first component is reconstructed using the predicted first component to produce a reconstructed first component. The reconstructed first component is computed from the predicted first component and the quantized residual first component.

At 130, a quality parameter or measure of the reconstructed first component is computed. For example, the quality parameter or measure may be computed by computing a squared sum or sum of absolute differences of the quantized residual first component.

At 135, the quality parameter or measure computed at 130 and/or the correlation coefficient computed at 120 is/are evaluated to determine whether it is/they are acceptable. The evaluation at 135 is made to determine whether the initially predicted second (third, fourth, etc.) component (computed at 115) should be used or whether a new predicted second (third, fourth, etc.) component should be used. For example, the quality parameter or measure is compared with a first threshold and the correlation coefficient is compared with a second threshold.

If it is determined at 135 that the quality parameter or measure is not acceptable, then at 140, the initially predicted second (third, fourth, etc.) component is used. For example, if the squared residual indicates acceptable (high) quality (that is, the squared residual less than a first threshold), the initially predicted second (third, fourth, etc.) component is used. Conversely, if the squared residual indicates unacceptable (low) quality (that is, the squared residual greater than or equal to the first threshold) and the correlation coefficient exceeds the second threshold, the new predicted second component is computed for the block. The new predicted second (third, fourth, etc.) component is computed based on the mapping function and the reconstructed first component of the block, and the new predicted second (third, fourth, etc.) component is used for the block. The new predicted component may be clipped to a valid range (e.g., 0-255 for 8 bit samples).

At 150, a reconstructed second (third, fourth, etc.) component is computed using either the initially predicted second (third, fourth, etc.) component computed at 140 or the new predicted second (third, fourth, etc.) component computed at 145, and a residual second (third, fourth, etc.) component (generated at the encoder) or decoded from the received bitstream (at the decoder).

The same operations are performed for a third component, fourth component, etc. For example, the first component may be a luminance (Y) component, the second component may be the U chrominance component and the third component may be the V chrominance component. Method 100 is performed for the third component in the same way as it is performed for the second component. That is, at 115, a third component is initially predicted for the block of pixels in the video frame. At 120, one or more parameters are computed for a mapping function between the first component and the third component based on a correlation between the predicted first component and the initially predicted third component for the block. Then, at 135, the quality parameter or measure (computed at 130) and the correlation coefficient (computed at 120 for the mapping function between the first component and the third component) are evaluated to determine whether they are acceptable. Depending on the quality parameter or measure and the correlation coefficient for the mapping function between the first component and the third component, either the initially predicted third component for the block is used or a new predicted third component for the block is computed based on the mapping function and a reconstructed first component for the block, and the new predicted third component is used for the block. If the squared residual indicates acceptable (high) quality (that is, the squared residual less than the first threshold), then at 140, the initially predicted third component is used for the block. If the squared residual indicates unacceptable (low) quality (that is, the squared residual greater than or equal to the first threshold) and the correlation coefficient for the mapping function between the first component and the third component exceeds the second threshold, the new predicted third component is computed for the block based on the mapping function and the reconstructed first component for the block, and that new predicted third component is used for the block.

A similar corresponding set of operations may be performed with respect to a fourth, fifth, etc., components.

As explained above, in one example, the first component is a luminance (Y) component, and the second and third components are chrominance (U and V or Cb and Cr) components.

When YUV images (or video frames) having chrominance subsampling are used, the Y prediction is subsampled (or the UV predictions upsampled) prior to calculating the mapping function. Finally, the new prediction is subsampled.

FIG. 2 illustrates, in more detail than FIG. 1, the operations of a process 200 performed at a video encoder for a three component example, according to an embodiment. Reference numeral 202A represents previously reconstructed spatially neighboring pixels for a first component and reference numeral 202B represents previously reconstructed temporally neighboring pixels for the first component. Reference numeral 204A represents previously reconstructed spatially neighboring pixels for a second component and reference numeral 204B represents previously reconstructed temporally neighboring pixels for the second component. Reference numeral 206A represents previously reconstructed spatially neighboring pixels for a third component and reference numeral 206B represents previously reconstructed temporally neighboring pixels for the third component. For intra-prediction, pixels 202A, 204A and 206A are used. For inter-prediction, pixels 202B, 204B and 206B are used.

The “compute prediction” step 210 corresponds to step 110 in FIG. 1, where a predicted first component is computed. Steps 212 and 214 correspond to step 115 in FIG. 1, where the initially predicted second component and the initially predicted third component are computed.

At 220, a mapping and one or more correlation coefficients are computed between the predicted first component computed at 210 and the initially predicted second component computed at 212. Similarly, at 222, a mapping and one or more correlation coefficients are computed between the predicted first component computed at 210 and the initially predicted third component computed at 214. Operations 220 and 222 correspond to step 120 in FIG. 1.

At 230, the reconstructed first component is computed, and this corresponds to step 125 in FIG. 1. The reconstructed first component is computed based on a residual for the first component computed at 232 and the predicted first component. The residual for the first component computed at 232 is also made available for transmission in the bitstream from the encoder to the decoder.

At 240, a squared residual (i.e., the aforementioned quality parameter or measure) is computed using the residual for the first component that is computed at 232. This squared residual is evaluated, together with the correlation coefficient, to determine whether the initial prediction computed at 212 and 214 is used or an improved prediction is computed. Specifically, at 250, the squared residual computed at 240 and the correlation coefficient computed at 220 are evaluated. If the squared residual indicates acceptable (high) quality (squared residual less than a first threshold), then the initial predicted second component is used at 252. On the other hand, if the squared residual indicates unacceptable (low) quality (greater than or equal to the first threshold) and the correlation coefficient (between the first component and the second component) is acceptable (greater than a second threshold), then improved prediction of the second component can be computed at 254. Operation 254 corresponds to operation 145 in FIG. 1 (for the second component).

Similarly, at 260, the squared residual computed at 240 and the correlation coefficient computed at 222 are evaluated. If the squared residual indicates acceptable (high) quality (squared residual less than a first threshold), then the initial predicted third component is used at 262. On the other hand, if the squared residual indicates unacceptable (low) quality (greater than or equal to the first threshold) and the correlation coefficient (between the first component and the third component) is acceptable (greater than a second threshold), then improved prediction of the third component can be computed at 264. Operation 264 corresponds to operation 145 in FIG. 1 (for the third component).

At 270, using either the new predicted second component (computed at 254) or the initial predicted second component (computed at 252), a residual for the second component is computed (which is included in the bitstream transmitted to the decoder) and used at 272 to compute a reconstructed second component. Similarly, at 280, using either the new predicted third component (computed at 264) or the initial predicted third component (computed at 262), a residual for the third component is computed (which is included in the bitstream transmitted to the decoder) and used at 282 to compute a reconstructed third component.

The “X's” in the arrows between 212 and 272, 212 and 270, 214 and 282, and 214 and 280, are meant to indicate that data does not flow between those operations, as would be the case in a conventional encoding scheme.

Reference is now made to FIG. 3. FIG. 3 is a flow diagram similar to FIG. 2, but showing the operations of a process 300 performed in a decoder. Reference numeral 302A represents previously reconstructed spatially neighboring pixels for a first component and reference numeral 302B represents previously reconstructed temporally neighboring pixels for the first component. Reference numeral 304A represents previously reconstructed spatially neighboring pixels for a second component and reference numeral 304B represents previously reconstructed temporally neighboring pixels for the second component. Reference numeral 306A represents previously reconstructed spatially neighboring pixels for a third component and reference numeral 306B represents previously reconstructed temporally neighboring pixels for the third component. For intra-prediction, pixels 302A, 304A and 306A are used. For inter-prediction, pixels 302B, 304B and 306B are used.

The “compute prediction” step 310 corresponds to step 110 in FIG. 1, where a predicted first component is computed. Steps 312 and 314 correspond to step 115 in FIG. 1, where the initially predicted second component and the initially predicted third component are computed.

At 320, a mapping and one or more correlation coefficients are computed between the predicted first component computed at 310 and the initially predicted second component computed at 312. Similarly, at 322, a mapping and one or more correlation coefficients are computed between the predicted first component computed at 310 and the initially predicted third component computed at 314. Operations 320 and 322 correspond to step 120 in FIG. 1.

At 330, the reconstructed first component is computed, and this corresponds to step 125 in FIG. 1. The reconstructed first component is computed based on a residual for the first component decoded from the received bitstream at 332 and the predicted first component.

At 340, a squared residual (the aforementioned quality parameter) is computed using the residual for the first component decoded from the received bitstream at 232. This squared residual is evaluated, together with the correlation coefficient, to determine whether the initial prediction computed at 312 and 314 is used or an improved prediction is computed. Specifically, at 350, the squared residual computed at 340 and the correlation coefficient computed at 320 are evaluated. If the squared residual indicates acceptable (high) quality (squared residual less than a first threshold), then the initial predicted second component is used at 352. On the other hand, if the squared residual indicates unacceptable (low) quality (greater than or equal to the first threshold) and the correlation coefficient (between the first component and the second component) is acceptable (greater than a second threshold), then improved prediction of the second component can be computed at 354. Operation 354 corresponds to operation 145 in FIG. 1 (for the second component).

Similarly, at 360, the squared residual computed at 340 and the correlation coefficient computed at 322 are evaluated. If the squared residual indicates acceptable (high) quality (squared residual less than a first threshold), then the initial predicted third component is used at 362. On the other hand, if the squared residual indicates unacceptable (low) quality (greater than or equal to the first threshold) and the correlation coefficient (between the first component and the third component) is acceptable (greater than a second threshold), then improved prediction of the third component can be computed at 364. Operation 364 corresponds to operation 145 in FIG. 1 (for the third component).

At 372, using either the new predicted second component (computed at 354) or the initial predicted second component (computed at 312), and a residual for the second component decoded from the received bitstream at 370, a reconstructed second component is computed. Similarly, at 382, using either the new predicted third component (computed at 364) or the initial predicted third component (computed at 314), and a residual for the third component decoded from the received bitstream at 380, a reconstructed third component is computed.

The “X's” in the arrows between 312 and 372, and 314 and 382, are meant to indicate that data does not flow between those operations, as data would be the case in a conventional decoding scheme.

The quality parameter or measure of the reconstructed first component is obtained by computing a squared sum of the quantized residual. The quantized residual is the quantized difference between the input video and the reconstructed video, i.e., what is transmitted to the decoder. The same quality computation is performed on the encoder side and decoder side. The residual is input to the encoder's transform and the quantized residual is the output from the decoder's inverse transform. In FIGS. 2 and 3, the phrases “residual for bitstream transmission” and “residual from bitstream” both refer to the “quantized residual”.

An efficient method of calculating a linear mapping function and a sample correlation coefficient is known as linear regression in statistics. Linear regression minimizes a square error. The following algorithm, as an example, may be used to compute the mapping function for a given block. The following description to luminance and chrominance as example components, only by way of example.

For every pixel y in the predicted n*m luminance block and for every corresponding pixel c in the initially predicted chrominance block calculate the following sums:

sum_y=sum_y+y

sum_c=sum_c+c

sum_yy=sum_yy+y*y

sum_cc=sum_cc+c*c

sum_yc=sum_yc+y*c

Then calculate the following:

diff_yy=sum_yy−sum_y*sum_y/(n*m)

diff_cc=sum_cc−sum_c*sum_c/(n*m)

diff_yc=sum_yc−sum_y*sum_c/(n*m)

If diff_yy is non-zero and diff_yc*diff_yc>r*diff_yy*diff_cc where r is the sample correlation coefficient, a value between 0 and 1, then the correlation is good enough and the slope a and the offset b can be calculated as:

a=diff_yc/diff_yy

b=sum_c−a*sum_y

The new chrominance prediction values c′ for the block can then be calculated using the corresponding reconstructed luminance values y′:

c′=clip(y′*a+b),

where clip is a function saturating the value to its allowed range. The mapping calculation method above is provided as an example only.

In less technical terms, in the YUV case, this method predicts the chrominance components using the luminance reconstruction and the components of the initial chrominance prediction. The assumption in this case is that the components can be identified by their luminosity. The method is applied on a per block basis, so the identification can be adaptive. Small blocks mean high adaptivity, but fewer samples and a less accurate mapping. Large blocks mean low adaptivity, but more samples and a more accurate mapping.

As explained above, this method is not limited to YUV video. Any format with correlation between the channels/components can benefit from this method. The YUV case has been chosen as an example for clarity and simplicity. YUV is also widely used.

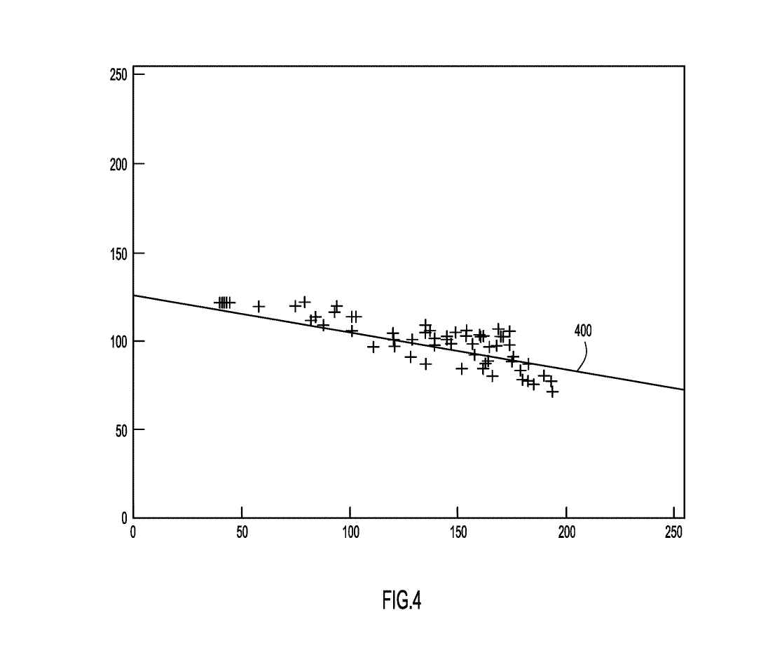

An example is now described with respect to FIG. 4. As explained above, the luminance component (Y) and chrominance components (U and V) are encoded separately (in that order), each component with its own initial prediction that have spatial or temporal dependencies only in its own component. Most of the perceived information of a video signal is to be found in the luminance component, but there still remain correlations between the luminance and chrominance components. For instance, the same shape of an object can usually be seen in all three components, and if this correlation is not exploited, some structural information will be transmitted three times. There is often a strong linear correlation between Y samples and U or V samples.

The graph of FIG. 4 shows values for an image block in which luminance samples have been plotted along one axis (X) and chrominance samples have been along the other axis (Y). A linear fit of the samples has also been plotted as shown at 400.

This suggests that it is possible to predict the chrominance components from the reconstructed luminance component using a simple linear function f(x)=a*x+b. It is, however, too costly to transmit the optimal a and b parameters. Instead, these are estimated using information shared by the encoder and decoder, so no extra information needs to be signaled. For example, correlation between the predicted luminance block and the predicted chrominance block may be used to find a and b, and if the correlation is reasonably strong, a new prediction cₚ=a*yᵣ+b is computed, where yᵣ is the reconstructed luminance value. For this to work the assumption is that the correlation between luminance and chrominance in the reconstructed block will be roughly the same as the correlation between luminance and chrominance in the initially predicted block.

In the example of luminance and chrominance components, the technique can be viewed as using the reconstructed luminance as a prediction for chrominance painted with the colors of the initial chrominance prediction. It is assumed that the colors can be identified by their luminance.

Since the assumption that the correlation is the same in the predicted block and in the reconstructed block is not always true, the new prediction from luminance might not be better even if the computed correlation found in the predicted block was very good. Therefore, an improvement is expected if the initial prediction is bad, and the reconstructed luminance residual is used as an estimate for this. For example, the chrominance prediction may be changed if the average squared value of an N×N block is above 64:

$$\frac{{\sum }_{i = 1}^{N} {\sum }_{j = 1}^{N} {{y}_{r} ( i , j )}^{2}}{{N}^{2}} > 64$$

For an N×N block in 4:4:4 format, a fit using a least square estimator can be computed:

$${y}_{sum} = {\sum }_{i = 1}^{N} {\sum }_{j = 1}^{N} {y}_{p} {c}_{sum} = {\sum }_{i = 1}^{N} {\sum }_{j = 1}^{N} {c}_{p} {yy}_{sum} = {\sum }_{i = 1}^{N} {\sum }_{j = 1}^{N} {y}_{p}^{2}$$

$${cc}_{sum} = {\sum }_{i = 1}^{N} {\sum }_{j = 1}^{N} {c}_{p}^{2} {yc}_{sum} = {\sum }_{i = 1}^{N} {\sum }_{j = 1}^{N} {y}_{p} {c}_{p}$$

In the case of 8 bit samples and N<=8, these sums can all be contained within a 32-bit signed integer. The following may be computed using 64-bit arithmetic:

ss_{yy}=yyₛᵤₘ−(yₛᵤₘ²>2 log₂(N))

ss_{cc}=ccₛᵤₘ−(cₛᵤₘ²>2 log₂(N))

ss_{yc}=ycₛᵤₘ−(yₛᵤₘcₛᵤₘ>2 log₂(N))

Still using 64-bit arithmetic, if ss_{yy}>0 and 2*ss_{yc}²>ss_{yy}*ss_{cc}, then there is a useful correlation and the slope a and offset b are computed. Integer division with truncation towards zero is used.

a=(ss_{yc}<<16)/ss_{yy}

b=((cₛᵤₘ<<16)−a×yₛᵤₘ)>>2 log₂(N)

The final operations are performed with 32-bit arithmetic: a is clipped to [−2²³, 2²³] and b is clipped to [−2³¹, 2³¹−1]. Now a new chrominance prediction cₚ′ is computed using yᵣ, a and b, and a clipping function saturating the result to an 8-bit value:

c_{p′}(i,j)=clip((ayᵣ(i,j)+b)>>16)

For the 4:2:0 format, the predicted luminance block is subsampled first:

y_{p′}(i,j)=(yₚ(2i,2j)+yₚ(2i+i,2j)+yₚ(2i,2j+1)+yₚ(2i+1,2j+1)+2)>>2

The resulting new chrominance prediction is also be subsampled. The clipping is performed before the sub sampling.

c_{p′}(i,j)=(clip((ayᵣ(2i,2j)+b)>>16)+clip(ayᵣ(2i+1,2j)+b)>>16)+clip((ayᵣ(2i,2j+1)+b)>>16)+clip((ayᵣ(2i+1,2j+1)+b)>>16)+2)>>2

When the prediction is computed from reconstructed pixels of the same frame, the chrominance prediction improvement is performed before the prediction of the next block.

The improved chrominance prediction may significantly improve the compression efficiency for images or video containing high correlations between the channels. It is particularly useful for encoding screen content, 4:4:4 content, high frequency content and “difficult” content where traditional prediction techniques perform poorly. Little quality change is seen for content not in these categories.

The blocks need not be square; they can be rectangular. Thus, all references to N*N herein can be generalized to N*M.

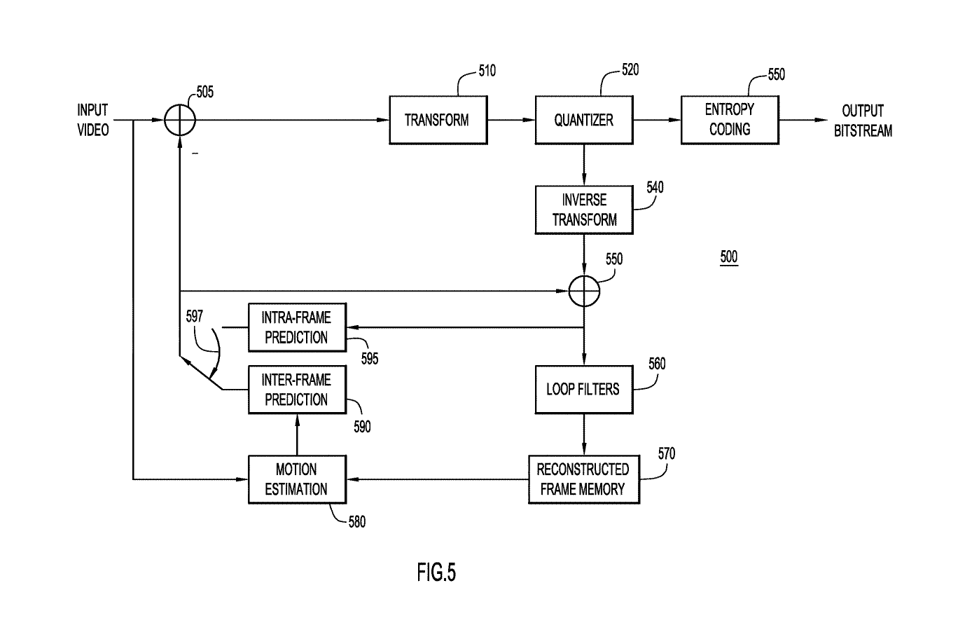

Referring to FIG. 5 a block diagram of a video encoder is shown at reference numeral 100. The video encoder 500 is configured to perform the prediction techniques presented herein. The video encoder 500 includes a subtractor 505, a transform unit 510, a quantizer unit 520, an entropy coding unit 530, an inverse transform unit 540, an adder 550, one or more loop filters 560, a reconstructed frame memory 570, a motion estimation unit 580, an inter-frame prediction unit 590, an intra-frame prediction unit 595 and a switch 597.

A current frame (input video) as well as a prediction frame are input to a subtractor 505. The subtractor 505 is provided with input from either the inter-frame prediction unit 590 or intra-frame prediction unit 595, the selection of which is controlled by switch 597. Intra-prediction processing is selected for finding similarities within the current image frame, and is thus referred to as “intra” prediction. Motion compensation has a temporal component and thus involves analysis between successive frames that is referred to as “inter” prediction. The motion estimation unit 580 supplies a motion estimation output as input to the inter-frame prediction unit 590. The motion estimation unit 580 receives as input the input video and an output of the reconstructed frame memory 570.

The subtractor 505 subtracts the output of the switch 597 from the pixels of the current frame, prior to being subjected to a two dimensional transform process by the transform unit 510 to produce transform coefficients. The transform coefficients are then subjected to quantization by quantizer unit 520 and then supplied to entropy coding unit 530. Entropy coding unit 530 applies entropy encoding in order to remove redundancies without losing information, and is referred to as a lossless encoding process. Subsequently, the encoded data is arranged in network packets via a packetizer (not shown), prior to be transmitted in an output bit stream.

The output of the quantizer unit 520 is also applied to the inverse transform unit 540 and used for assisting in prediction processing. The adder 550 adds the output of the inverse transform unit 540 and an output of the switch 597 (either the output of the inter-frame prediction unit 590 or the intra-frame prediction unit 595). The output of the adder 550 is supplied to the input of the intra-frame prediction unit 595 and to one or more loop filters 560 which suppress some of the sharpness in the edges to improve clarity and better support prediction processing. The output of the loop filters 560 is applied to a reconstructed frame memory 570 that holds the processed image pixel data in memory for use in subsequent motion processing by motion estimation block 580.

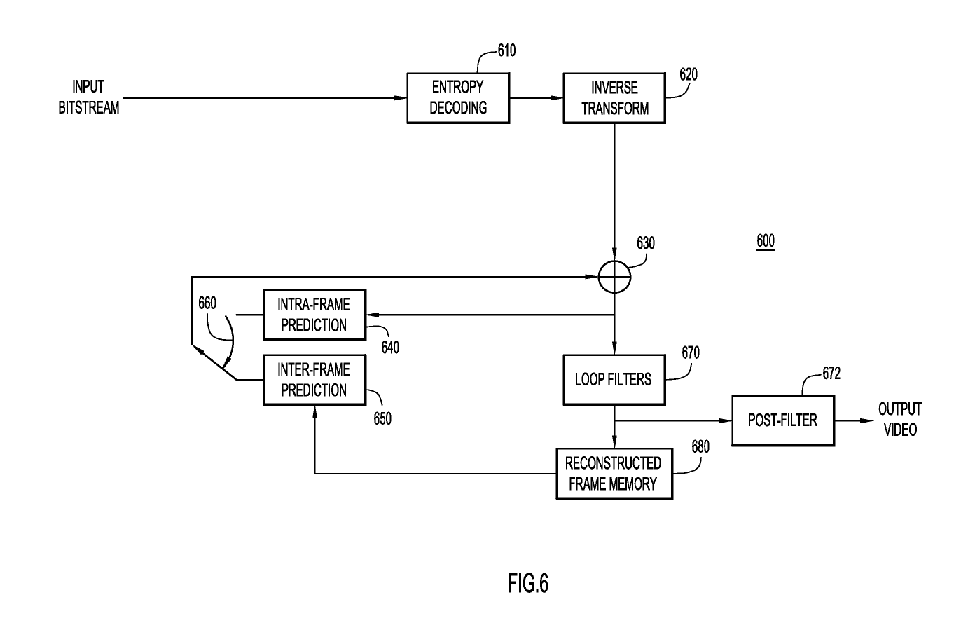

Turning to FIG. 6, a block diagram of a video decoder is shown at reference numeral 200. The video decoder 600 includes an entropy decoding unit 610, an inverse transform unit 620, an adder 630, an intra-frame prediction unit 640, an inter-frame prediction unit 650, a switch 660, one or more loop filters 670 and a reconstructed frame memory 680. The order of the filters agree with the order used in the encoder. In addition, a post-filter 672 is shown in FIG. 6. The entropy decoding unit 610 performs entropy decoding on the received input bitstream to produce quantized transform coefficients which are applied to the inverse transform unit 620. The inverse transform unit 620 applies two-dimensional inverse transformation on the quantized transform coefficients to output a quantized version of the difference samples. The output of the inverse transform unit 620 is applied to the adder 630. The adder 630 adds to the output of the inverse transform unit 620 an output of either the intra-frame prediction unit 640 or inter-frame prediction unit 650. The loop filters 670 operate similar to that of the loop filters 560 in the video encoder 100 of FIG. 5. An output video image is taken at the output of the loop filters 670.

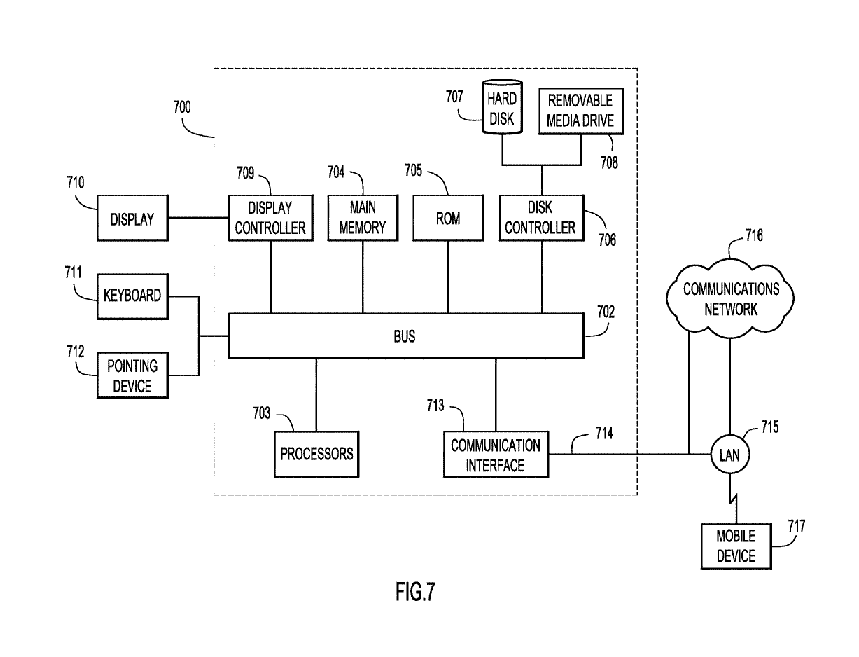

The video encoder 500 of FIG. 5 and the video decoder 600 of FIG. 6 may be implemented by digital logic gates in an integrated circuit (e.g., by an application specific integrated circuit) or by two or more separate logic devices. Alternatively, the video encoder 500 and video decoder 600 may be implemented by software executed by one or more processors, as described further in connection with FIG. 7, below.

Each of the functional blocks in FIGS. 5 and 6 are executed for each coding block, prediction block, or transform block.

FIG. 7 illustrates a computer system 700 upon which an embodiment of the present invention may be implemented. The computer system 700 may be programmed to implement a computer based device, such as a video conferencing endpoint or any device includes a video encoder or decoder for processing real time video images. The computer system 700 includes a bus 702 or other communication mechanism for communicating information, and a processor 703 coupled with the bus 702 for processing the information. While the figure shows a signal block 703 for a processor, it should be understood that the processors 703 represent a plurality of processing cores, each of which can perform separate processing. The computer system 700 also includes a main memory 704, such as a random access memory (RAM) or other dynamic storage device (e.g., dynamic RAM (DRAM), static RAM (SRAM), and synchronous DRAM (SD RAM)), coupled to the bus 702 for storing information and instructions to be executed by processor 703. In addition, the main memory 704 may be used for storing temporary variables or other intermediate information during the execution of instructions by the processor 703.

The computer system 700 further includes a read only memory (ROM) 705 or other static storage device (e.g., programmable ROM (PROM), erasable PROM (EPROM), and electrically erasable PROM (EEPROM)) coupled to the bus 702 for storing static information and instructions for the processor 703.

The computer system 700 also includes a disk controller 706 coupled to the bus 702 to control one or more storage devices for storing information and instructions, such as a magnetic hard disk 707, and a removable media drive 708 (e.g., floppy disk drive, read-only compact disc drive, read/write compact disc drive, compact disc jukebox, tape drive, and removable magneto-optical drive). The storage devices may be added to the computer system 700 using an appropriate device interface (e.g., small computer system interface (SCSI), integrated device electronics (IDE), enhanced-IDE (E-IDE), direct memory access (DMA), or ultra-DMA).

The computer system 700 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)), that, in addition to microprocessors and digital signal processors may individually, or collectively, are types of processing circuitry. The processing circuitry may be located in one device or distributed across multiple devices.

The computer system 700 may also include a display controller 709 coupled to the bus 702 to control a display 710, such as a cathode ray tube (CRT), liquid crystal display (LCD), light emitting diode (LED) display, or any other display technology now known or hereinafter developed, for displaying information to a computer user. The computer system 700 includes input devices, such as a keyboard 711 and a pointing device 712, for interacting with a computer user and providing information to the processor 703. The pointing device 712, for example, may be a mouse, a trackball, or a pointing stick for communicating direction information and command selections to the processor 703 and for controlling cursor movement on the display 710. In addition, a printer may provide printed listings of data stored and/or generated by the computer system 700.

The computer system 700 performs a portion or all of the processing steps of the invention in response to the processor 703 executing one or more sequences of one or more instructions contained in a memory, such as the main memory 704. Such instructions may be read into the main memory 704 from another computer readable medium, such as a hard disk 707 or a removable media drive 708. One or more processors in a multi-processing arrangement may also be employed to execute the sequences of instructions contained in main memory 704. In alternative embodiments, hard-wired circuitry may be used in place of or in combination with software instructions. Thus, embodiments are not limited to any specific combination of hardware circuitry and software.

As stated above, the computer system 700 includes at least one computer readable medium or memory for holding instructions programmed according to the embodiments presented, for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SD RAM, or any other magnetic medium, compact discs (e.g., CD-ROM), or any other optical medium, punch cards, paper tape, or other physical medium with patterns of holes, or any other medium from which a computer can read.

Stored on any one or on a combination of non-transitory computer readable storage media, embodiments presented herein include software for controlling the computer system 700, for driving a device or devices for implementing the invention, and for enabling the computer system 700 to interact with a human user (e.g., print production personnel). Such software may include, but is not limited to, device drivers, operating systems, development tools, and applications software. Such computer readable storage media further includes a computer program product for performing all or a portion (if processing is distributed) of the processing presented herein.

The computer code devices may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

The computer system 700 also includes a communication interface 713 coupled to the bus 702. The communication interface 713 provides a two-way data communication coupling to a network link 714 that is connected to, for example, a local area network (LAN) 715, or to another communications network 716 such as the Internet. For example, the communication interface 713 may be a wired or wireless network interface card to attach to any packet switched (wired or wireless) LAN. As another example, the communication interface 713 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 713 sends and receives electrical, electromagnetic or optical signals that carry digital data streams representing various types of information.

The network link 714 typically provides data communication through one or more networks to other data devices. For example, the network link 714 may provide a connection to another computer through a local are network 715 (e.g., a LAN) or through equipment operated by a service provider, which provides communication services through a communications network 716. The local network 714 and the communications network 716 use, for example, electrical, electromagnetic, or optical signals that carry digital data streams, and the associated physical layer (e.g., CAT 5 cable, coaxial cable, optical fiber, etc.). The signals through the various networks and the signals on the network link 714 and through the communication interface 713, which carry the digital data to and from the computer system 700 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 700 can transmit and receive data, including program code, through the network(s) 715 and 716, the network link 714 and the communication interface 713. Moreover, the network link 714 may provide a connection through a LAN 715 to a mobile device 717 such as a personal digital assistant (PDA) laptop computer, or cellular telephone.

Techniques are presented herein for exploiting correlations between channels of an image or video frame to be encoded. The correlations between channels in an initial prediction are used to calculate the mapping. The method also determines whether the new prediction is an improvement over the original prediction if no extra signaling is to be used. The method may significantly improve the compression efficiency for images or video containing high correlations between the channels. This is particularly useful for encoding screen content, 4:4:4 content, high frequency content (possibly including “gaming” content) and “difficult” content where traditional prediction techniques perform poorly. It may also be useful to predict an alpha channel.

In one form, a method is provided comprising: A method comprising: predicting a first component for a block of pixels in a video frame and producing a predicted first component; initially predicting a second component for a block of pixels in a video frame and producing an initially predicted second component; computing one or more parameters for a mapping function between the first component and the second component for the block based on a correlation between the predicted first component and the initially predicted second component for the block; computing a quality parameter or measure of a reconstructed first component; computing a correlation coefficient for the mapping function between the first component and the second component; and depending on the quality parameter or measure and the correlation coefficient, either using the initially predicted second component for the block or computing a new predicted second component for the block based on the mapping function and a reconstructed first component for the block.

As explained above, if the quality parameter is less than the first threshold indicating acceptable quality, the initially predicted second component is used for the block, and if the quality parameter is greater than or equal to the first threshold, indicating unacceptable quality, and the correlation coefficient exceeds the second threshold, the new predicted second component is computed for the block. Furthermore, a third component is initially predicted for the block of pixels in the video frame to produce an initially predicted third component; one or more parameters for a mapping function between the first component and a third component are computed for the block based on a correlation between the predicted first component and the initially predicted third component for the block. A correlation coefficient is computed for the mapping function between the first component and the third component. Depending on the quality parameter and the correlation coefficient for the mapping function between the first component and the third component, either the initially predicted third component is used for the block or a new predicted third component is computed for the block based on the mapping function and the reconstructed first component for the block. Further still, if the quality parameter is less than the first threshold indicating acceptable quality, the initially predicted third component is used for the block, and if the quality parameter is greater than or equal to the first threshold, indicating unacceptable quality, and the correlation coefficient for the mapping function between the first component and the third component exceeds the second threshold, the new predicted third component is computed for the block.

In another form, an apparatus is provided comprising: a communication interface configured to enable communications over a network; a memory; and a processor coupled to the communication interface and the memory, wherein the processor is configured to: predict a first component for a block of pixels in a video frame to produce a predicted first component; initially predicting a second component for a block of pixels in a video frame to produce an initially predicted second component; compute one or more parameters for a mapping function between the first component and the second component for the block based on a correlation between the predicted first component and the initially predicted second component for the block; compute a quality parameter or measure of a reconstructed first component; compute a correlation coefficient for the mapping function between the first component and the second component; and depending on the quality parameter or measure and the correlation coefficient, either use the initially predicted second component for the block or compute a new predicted second component for the block based on the mapping function and a reconstructed first component for the block.

In yet another form, one or more non-transitory computer readable storage media are provided encoded with software comprising computer executable instructions and when the software is executed operable to perform operations comprising: predicting a first component for a block of pixels in a video frame to produce a predicted first component; initially predicting a second component for a block of pixels in a video frame to produce an initially predicted second component; computing one or more parameters for a mapping function between the first component and the second component for the block based on a correlation between the predicted first component and the initially predicted second component for the block; computing a quality parameter or measure of a reconstructed first component; computing a correlation coefficient for the mapping function between the first component and the second component; and depending on the quality parameter or measure and the correlation coefficient, either using the initially predicted second component for the block or computing a new predicted second component for the block based on the mapping function and a reconstructed first component for the block.

The above description is intended by way of example only. The present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Although the techniques are illustrated and described herein as embodied in one or more specific examples, it is nevertheless not intended to be limited to the details shown, since various modifications and structural changes may be made within the scope and range of equivalents of this disclosure.

What is claimed is:

1. A method comprising:
predicting a first component for a block of pixels in a video frame and producing a predicted first component;
initially predicting a second component for a block of pixels in a video frame and producing an initially predicted second component;
computing one or more parameters for a mapping function between the first component and the second component for the block based on a correlation between the predicted first component and the initially predicted second component for the block;
computing a quality parameter of a reconstructed first component;
computing a correlation coefficient for the mapping function between the first component and the second component; and
depending on the quality parameter and the correlation coefficient, either using the initially predicted second component for the block or computing a new predicted second component for the block based on the mapping function and a reconstructed first component for the block.

2. The method of claim 1, further comprising comparing the quality with a first threshold and comparing the correlation coefficient with a second threshold.

3. The method of claim 2, wherein if the quality parameter is less than the first threshold indicating acceptable quality, using the initially predicted second component for the block, and if the quality parameter is greater than or equal to the first threshold, indicating unacceptable quality, and the correlation coefficient exceeds the second threshold, computing the new predicted second component for the block.

4. The method of claim 1, further comprising:
initially predicting a third component for the block of pixels in the video frame to produce an initially predicted third component;
computing one or more parameters for a mapping function between the first component and a third component for the block based on a correlation between the predicted first component and the initially predicted third component for the block;
computing a correlation coefficient for the mapping function between the first component and the third component; and
depending on the quality parameter and the correlation coefficient for the mapping function between the first component and the third component, either using the initially predicted third component for the block or computing a new predicted third component for the block based on the mapping function and the reconstructed first component for the block.

5. The method of claim 4, wherein if the quality parameter is less than the first threshold indicating acceptable quality, using the initially predicted third component for the block, and if the quality parameter is greater than or equal to the first threshold, indicating unacceptable quality, and the correlation coefficient for the mapping function between the first component and the third component exceeds the second threshold, computing the new predicted third component for the block.

6. The method of claim 4, wherein the first component is a luminance (Y) component, and the second and third components are chrominance (U and V or Cb and Cr) components.

7. The method of claim 3, wherein the block is predicted based on spatially neighboring pixels in the video frame.

8. The method of claim 3, wherein the block is predicted based on temporally neighboring pixels in another video frame.

9. The method of claim 1, wherein the mapping function is a linear function.

10. The method of claim 1, wherein the one or more parameters for the mapping function are computed using linear regression.

11. The method of claim 1, further comprising:
computing the reconstructed first component for the block using the predicted first component and a residual first component; and
computing a reconstructed second component for the block using either the initially predicted second component or the new predicted second component.

12. The method of claim 11, wherein computing the quality parameter comprises computing a square sum of the residual for the first component.

13. An apparatus comprising:
a communication interface configured to enable communications over a network;
a memory; and
a processor coupled to the communication interface and the memory, wherein the processor is configured to:
predict a first component for a block of pixels in a video frame to produce a predicted first component;
initially predicting a second component for a block of pixels in a video frame to produce an initially predicted second component;
compute one or more parameters for a mapping function between the first component and the second component for the block based on a correlation between the predicted first component and the initially predicted second component for the block;
compute a quality parameter of a reconstructed first component;
compute a correlation coefficient for the mapping function between the first component and the second component; and
depending on the quality parameter and the correlation coefficient, either use the initially predicted second component for the block or compute a new predicted second component for the block based on the mapping function and a reconstructed first component for the block.

14. The apparatus of claim 13, wherein the processor is further configured to:
compare the quality parameter with a first threshold;
compare the correlation coefficient with a second threshold;
if the quality parameter is less than the first threshold indicating acceptable quality, use the initially predicted second component for the block, and if the quality parameter is greater than or equal to the first threshold, indicating unacceptable quality, and the correlation coefficient exceeds the second threshold, compute the new predicted second component for the block.

15. The apparatus of claim 13, wherein the processor is further configured to:
initially predict a third component for the block of pixels in the video frame to produce an initially predicted third component;
compute one or more parameters for a mapping function between the first component and a third component for the block based on a correlation between the predicted first component and the initially predicted third component for the block;
compute a correlation coefficient for the mapping function between the first component and the third component; and
depending on the quality parameter and the correlation coefficient for the mapping function between the first component and the third component, either use the initially predicted third component for the block or compute a new predicted third component for the block based on the mapping function and the reconstructed first component for the block.

16. The apparatus of claim 15, wherein the processor is configured to:
if the quality parameter is less than or equal to the first threshold indicating acceptable quality, use the initially predicted third component for the block, and if the quality parameter is greater than or equal to the first threshold, indicating unacceptable quality, and the correlation coefficient for the mapping function between the first component and the third component exceeds the second threshold, compute the new predicted third component for the block.

17. One or more non-transitory computer readable storage media encoded with software comprising computer executable instructions and when the software is executed operable to perform operations comprising:
predicting a first component for a block of pixels in a video frame to produce a predicted first component;
initially predicting a second component for a block of pixels in a video frame to produce an initially predicted second component;
computing one or more parameters for a mapping function between the first component and the second component for the block based on a correlation between the predicted first component and the initially predicted second component for the block;
computing a quality parameter of a reconstructed first component;
computing a correlation coefficient for the mapping function between the first component and the second component; and
depending on the quality parameter and the correlation coefficient, either using the initially predicted second component for the block or computing a new predicted second component for the block based on the mapping function and a reconstructed first component for the block.

18. The non-transitory computer readable storage media of claim 17, further comprising instructions operable for performing operations including:
comparing the quality parameter with a first threshold and comparing the correlation coefficient with a second threshold; and
if the quality parameter is less than the first threshold indicating acceptable quality, using the initially predicted second component for the block, and if the quality parameter is greater than or equal to the first threshold, indicating unacceptable quality, and the correlation coefficient exceeds the second threshold, computing the new predicted second component for the block.

19. The non-transitory computer readable storage media of claim 17, further comprising instructions operable for performing operations including:
initially predicting a third component for the block of pixels in the video frame to produce an initially predicted third component;
computing one or more parameters for a mapping function between the first component and a third component for the block based on a correlation between the predicted first component and the initially predicted third component for the block;
computing a correlation coefficient for the mapping function between the first component and the third component; and
depending on the quality parameter and the correlation coefficient for the mapping function between the first component and the third component, either using the initially predicted third component for the block or computing a new predicted third component for the block based on the mapping function and the reconstructed first component for the block.

20. The non-transitory computer readable storage media of claim 19, further comprising instructions operable for performing operations including:
if the quality parameter is less than the first threshold indicating acceptable quality, using the initially predicted third component for the block, and if the quality parameter is greater than or equal to the first threshold, indicating unacceptable quality, and the correlation coefficient for the mapping function between the first component and the third component exceeds the second threshold, computing the new predicted third component for the block.
